(19) United States
(12) Patent Application Publication
(10) Pub. No.: US 2010/0067246 A1
(43) Pub. Date: Mar. 18, 2010

(54) VEHICLE STRUCTURE

(75) Inventor: Brian Skiba, Farmington, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 12/212,374

(22) Filed: Sep. 17, 2008

(51) Int. Cl. B60Q 1/00

(52) U.S. Cl. 362/487

(57) ABSTRACT

A vehicle body includes a lamp housing receiving portion, a access opening adjacent to the lamp housing receiving portion, a vehicle closure member, a lamp housing and a lamp lens. The vehicle closure member is movable between an open position exposing the access opening and a closed position covering the door opening. The lamp housing is removably disposed within the lamp housing receiving portion having at least one lamp receiving portion and an inboard lens attachment portion. The lamp lens is configured to allow transmission of light therethrough having an inboard housing attachment portion that is fixedly attached to the inboard lens attachment portion. The inboard housing attachment portion and the inboard lens attachment portion are disposed inboard of an outboard lateral edge of the vehicle closure member and concealed by the vehicle closure member when the vehicle closure member is in the closed position.

### BACKGROUND OF THE INVENTION

1. Field of the Invention

The present invention relates to a vehicle lamp assembly having a lens portion and a housing portion. More specifically, the present invention relates to a vehicle lamp assembly with a seam between the lens and housing portions that is hidden behind an adjacent vehicle closure member with the vehicle closure member in a closed position.

2. Background Information

In recent years, vehicle lamp assemblies have been constructed as a hollow monolithic structure that includes a lens portion and a housing portion that supports an electric light bulb. The lens portion and the housing portion are each typically made as separate elements with plastic and/or polymer materials. The lens portion and the housing portion are subsequently fused, glued, hot melt welded or otherwise permanently fixed to on another to form the monolithic structure. Specifically, a peripheral edge of the lens portion is fixed to a correspondingly shaped receiving surface formed on the housing portion. A seam is then formed between the peripheral edge of the lens portion and receiving surface of the housing portion. Typically, visible sections of the seam are unattractive or unsightly.

In view of the above, it will be apparent to those skilled in the art from this disclosure that there exists a need for an improved vehicle headlamp assembly that eliminates the unattractive or unsightly sections of the seam between the housing portion and the lens portion. This invention addresses this need in the art as well as other needs, which will become apparent to those skilled in the art from this disclosure.

### SUMMARY OF THE INVENTION

One object of the present invention is to eliminate or obscure unattractive or unsightly sections of a seam between a housing portion and a lens portion of a vehicle lamp assembly.

In accordance with one aspect of the present invention, a vehicle structure includes a vehicle body, a vehicle closure member, a lamp housing and a lamp lens. The vehicle body has a lamp housing receiving portion and defines an access opening inboard to the lamp housing receiving portion. The vehicle closure member is supported on the vehicle body to move between an open position exposing the access opening and a closed position covering the access opening. The vehicle closure member also has an outboard lateral edge. The lamp housing is removably disposed within the lamp housing receiving portion having at least one lamp receiving portion and an inboard lens attachment portion. The lamp lens is configured to allow transmission of light therethrough and has an inboard housing attachment portion that is fixedly attached to the inboard lens attachment portion. The inboard housing attachment portion and the inboard lens attachment portion are disposed inboard of the outboard lateral edge of the vehicle closure member and concealed by the vehicle closure member when the vehicle closure member is in the closed position.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side view of a vehicle that includes a tail lamp assembly in accordance with the present invention;

FIG. 2 is a rear view of the vehicle showing the tail lamp assembly and a rear door with a seam of the tail lamp assembly covered and hidden with the rear door in a closed position in accordance with the present invention;

FIG. 3 is another rear view of the vehicle similar to FIG. 2 showing the rear door in an open position exposing a rear opening of the vehicle and the seam of the tail lamp assembly in accordance with the present invention;

FIG. 4 is a perspective rear view of the vehicle showing tail lamp assembly with the rear door in the closed position covering and hiding of the seam of the tail lamp assembly in accordance with the present invention;

FIG. 5 is a perspective view of the vehicle with the rear door in the open position (and hence not shown) and with the tail lamp assembly removed revealing a lamp housing receiving portion and a recessed surface that partially surrounds the rear opening of the vehicle in accordance with the present invention;

FIG. 6 is an exploded perspective view of the tail lamp assembly removed from the vehicle showing a housing portion and an outer side of a lens portion prior to assembly in accordance with the present invention;

FIG. 7 is a perspective view of an inner side of the lens portion of the tail lamp assembly shown removed from the housing portion in accordance with the present invention;

FIG. 8 is a cross-sectional view of the rear of the vehicle taken along the line 8-8 in FIG. 4, in accordance with the present invention; and

FIG. 9 is another cross-sectional view of the rear of the vehicle similar to FIG. 8 showing only the lens portion and the housing portion of the lamp assembly prior to assembly in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

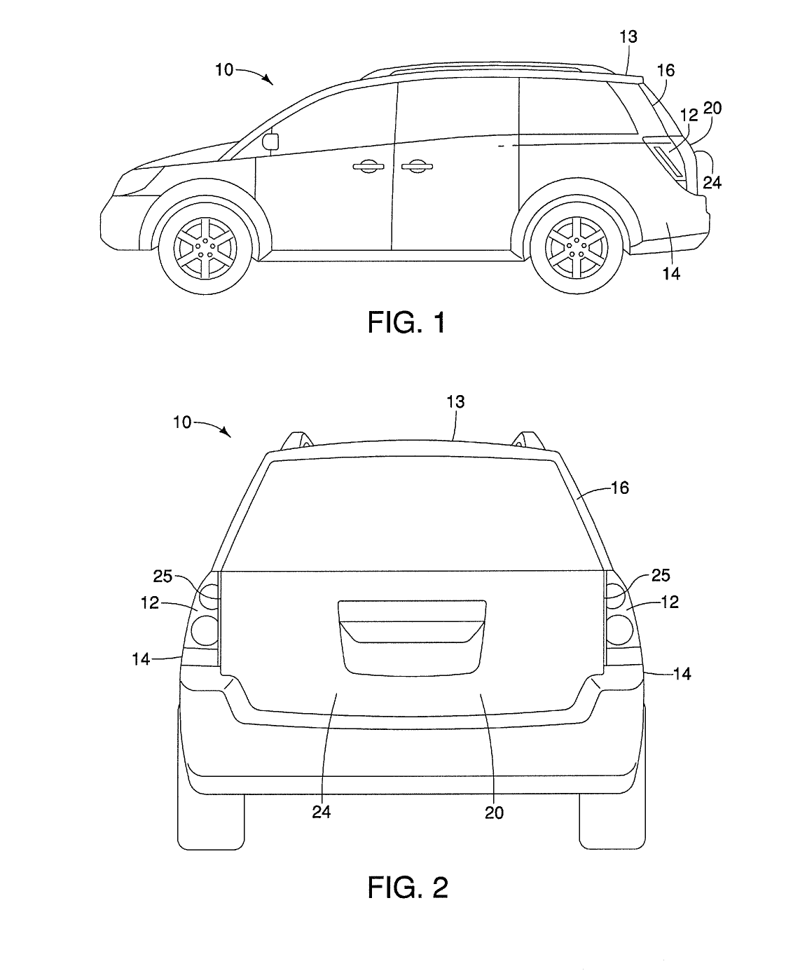

Referring initially to FIG. 1, a vehicle 10 with a lamp assembly 12 is illustrated in accordance with a first embodiment of the present invention. In the depicted embodiment, the vehicle 10 is a van. However, it should be understood from the drawings and the description herein that the vehicle 10 can be sedan, SUV or other similar vehicle.

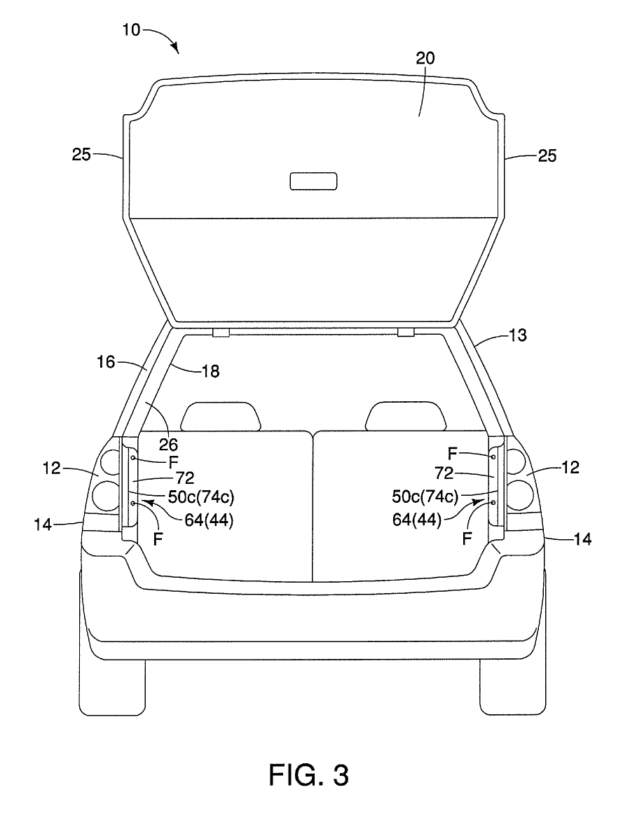

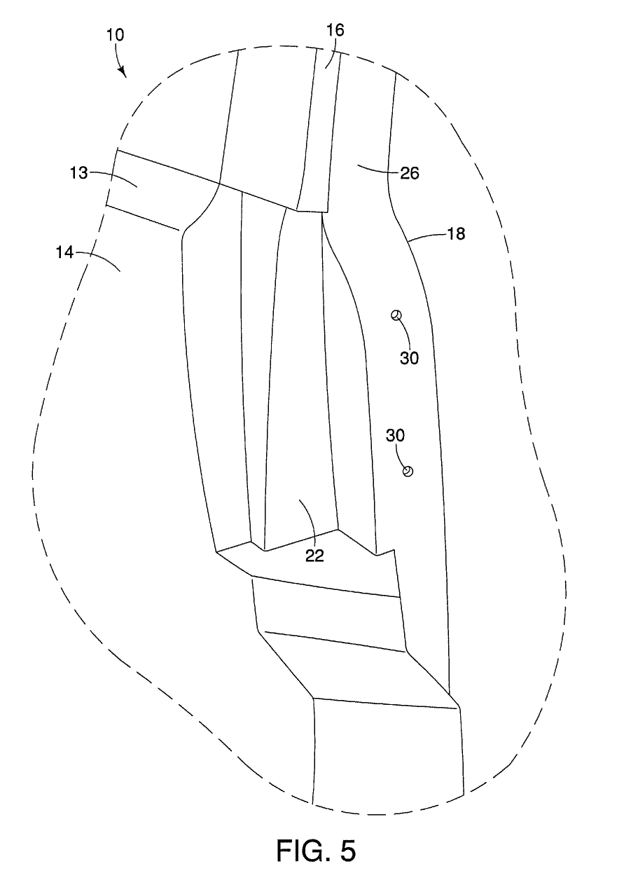

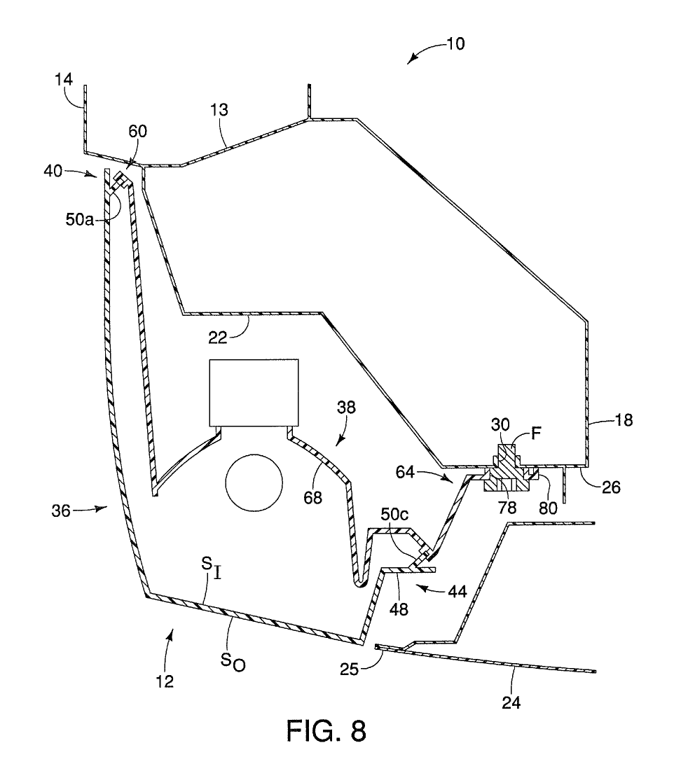

As best shown in FIGS. 2 and 3, the vehicle 10 includes a vehicle body 13 with side surfaces 14, an outer rear surface 16, an access opening 18 formed in the outer rear surface 16, a closure member 20 and a lamp housing receiving recess 22 that is shown in FIGS. 5 and 8. The closure member 20 is supported on the vehicle 10 to move between an open position (FIG. 3) exposing the access opening 18 and a closed position (FIG. 2) covering the access opening 18.

The access opening 18 is depicted as a rear access to a van and the closure member 20 depicted as a hatch cover or door that covers and seals the access opening 18. However it should be understood that the access opening 18 can be a trunk opening, a truck rear door opening, or engine compartment opening. Similarly, the closure member 20 can be a trunk lid, a truck rear door or a hood of an engine compartment.

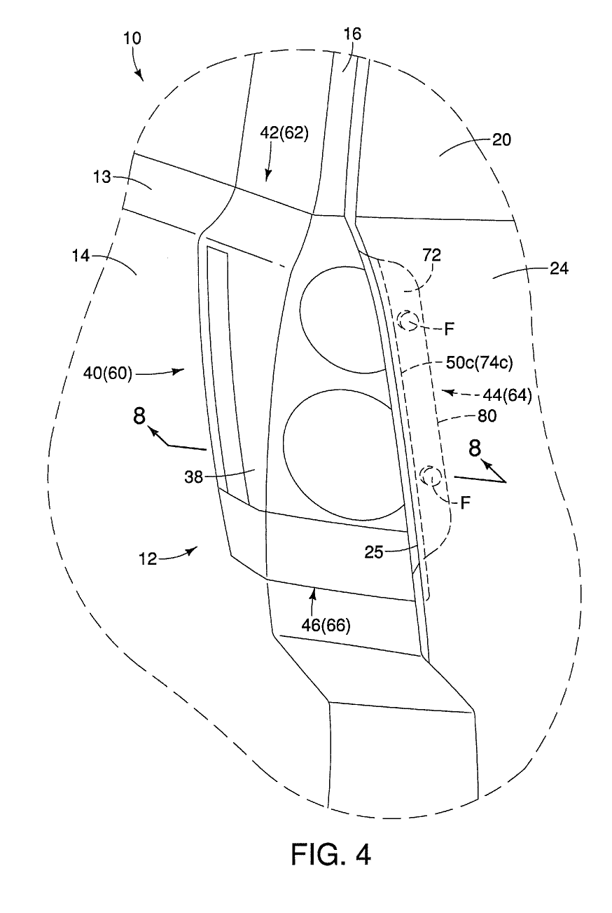

As best shown in FIGS. 2 and 4, the closure member 20 has a contoured outer surface 24 and an outboard lateral edge 25. With the closure member 20 in the closed position, the edges of the contoured outer surface 24 (including the outboard lateral edge 25) of the closure member 20 conform to and blend in with the outer rear surface 16, as indicated in FIG. 4. The contoured outer surface 24 has a curved shape. Specifically, the outer edges of the closure member 20 are even with the outer rear surface 16, as indicated in FIGS. 2 and 4. However, the curvature of the closure member 20 is such that a central portion appears to extend rearward beyond the outer rear surface 16, when viewed from the side, as in FIG. 1.

As best shown in FIG. 3, the vehicle 10 also includes a recessed surface 26 that at least partially surrounds the access opening 18. Specifically, the recessed surface 26 extends around the sides and top portions of the access opening 18 and at least partially defines the access opening 18, as indicated in FIG. 3. The recessed surface 26 is offset from the outer rear surface 16 in order to receive the closure member 20 with the closure member 20 in the closed position. More specifically, the recessed surface 26 is dimensioned such that with the closure member 20 in the closed position, the contoured outer surface 24 of the closure member 20 is even with the outer rear surface 16 of the vehicle body 13, as indicated in FIG. 4. As indicated in FIGS. 5 and 8, a section of the recessed surface 26 is adjacent and open to the lamp housing receiving recess 22.

In the following description of the lamp assembly 12, the two sides of the rear of the vehicle 10 are the same, except that they are symmetrical with respect to one another. Therefore, only one side of the rear of the vehicle 10 is included for the sake of brevity. Description of one side of the rear of the vehicle 10 applies to the other side. Similarly, although there are two lamp assemblies 12, since the lamp assemblies 12 are the same (but symmetrical), description of only one lamp assembly 12 is provided for the sake of brevity.

As shown in FIG. 5, the section of the recessed surface 26 adjacent to the lamp housing receiving recess 22 includes a pair of fastener receiving apertures 30.

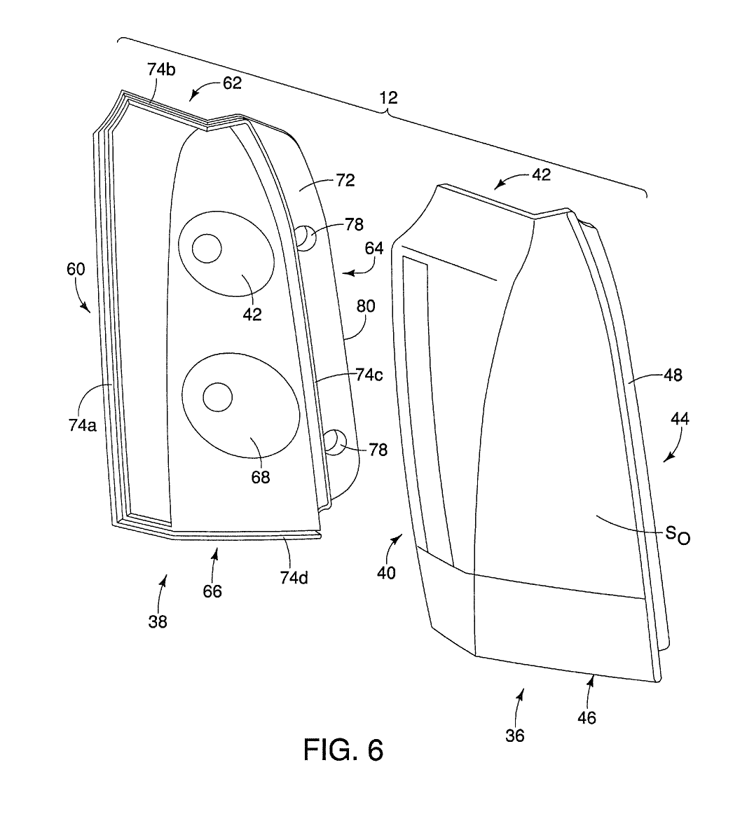

A description of the lamp assembly 12 is now provided with specific reference to FIGS. 6-9. The lamp assembly 12 basically includes a lens portion 36 and a housing portion 38. In the depicted embodiment, the lamp assembly 12 is a tail lamp assembly. However it should be understood from the drawings and the description herein that the lamp assembly 12 can be a headlamp assembly adjacent to the hood of an engine compartment or other lamp assembly adjacent to any door of a vehicle.

As best shown in FIGS. 6 and 8, the housing portion 38 (a lamp housing) is shaped to be removably disposed within in the lamp housing receiving recess 22. The housing portion 38 and the lamp housing receiving recess 22 can have any of a variety of complimentary shapes and contours that are not limited to the depicted shapes and contours. Rather, the complimentary shapes and contours of the housing portion 38 and the lamp housing receiving recess 22 are dependent upon the type of lamp (headlamp or tail lamp) and their location on the vehicle body 13 of the vehicle 10.

A description of the lens portion 36 of the lamp assembly 12 is now provided with specific reference to FIGS. 6, 7, 8 and 9. The lens portion 36 is a contoured member that has a contoured outer surface S_{O}, a contoured inner surface S_{I}. The contoured outer surface So is shaped and contoured to complement the overall shape of the vehicle body 13 and is not limited to the depicted shapes and contours. Rather, it should be understood from the description and drawings herein that the lens portion 36 can have any of a variety of shapes and contours depending upon the overall shape and contours of the vehicle body 13 and the location of the lamp assembly 12 relative to the vehicle body 13.

The lens portion 36 is preferably made of a molded polymer or plastic material that is primarily transparent allowing the transmission of light therethrough but can also include translucent sections. The lens portion 36 basically includes an outboard section 40, an upper section 42, an inboard section 44 and a lower section 46. The inboard section 44 is further formed with an inboard flange 48.

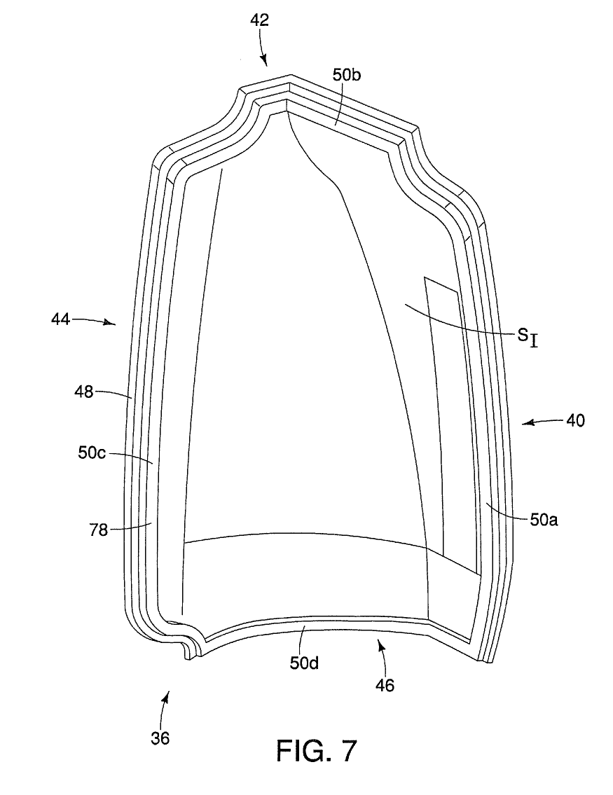

In FIG. 7, the features of the contoured inner surface S_{I} are depicted. Specifically, on the contoured inner surface S_{I} the outboard section 40 is formed with a lip 50a, the upper section 42 is formed with a lip 50b, the inboard section 44 is formed with a lip 50c and the lower section 46 is formed with a lip 50d. The lips 50a, 50b, 50c and 50d together define a single projection or lip that extends completely around the contoured inner surface S_{I}. As is best shown in FIGS. 7, 8 and 9, the lip 50c is formed on the inboard flange 48 of the inboard section 44 of the lens portion 36. The lips 50a, 50b, 50c and 50d further define respective housing attachment portions. More specifically, the lip 50a defines an outboard housing attachment portion, the lip 50b defines an upper housing attachment portion, the lip 50c defines an inboard housing attachment portion and the lip 50d defines a lower housing attachment portion.

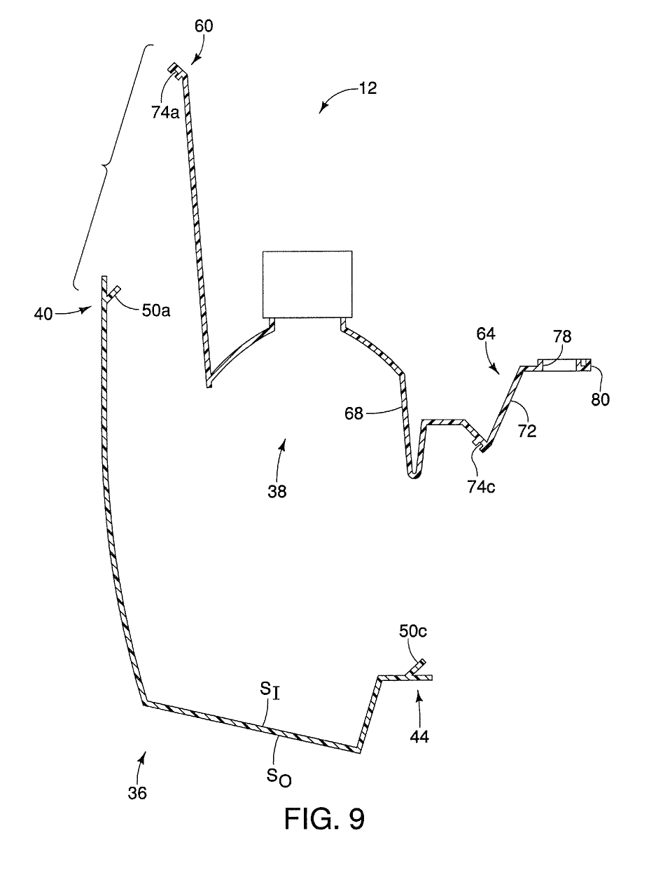

A description of the housing portion 38 of the lamp assembly 12 is now provided with specific reference to FIGS. 6, 8 and 9. The housing portion 38 is preferably made of a molded plastic or polymer material. The housing portion 38 is preferably non-transparent and/or is covered with a non-transparent coating. The housing portion 38 basically includes an outboard section 60, an upper section 62, an inboard section 64 and a lower section 66. A central area of the housing portion 38 further includes a first reflecting cone 68 and a second reflecting cone 70. The first and second reflecting cones 68 and 70 are configured to receive and support light sources (not shown) that can be configured to serve as conventional brake lights, backup lights and signal lights. The inboard section 64 of the housing portion 38 also includes a mounting flange 72. The outboard section 60 is formed with a recess 74a, the upper section 62 is formed with a recess 74b, the inboard section 64 is formed with a recess 74c and the lower section 66 is formed with a recess 74d. The recesses 74a, 74b, 74c and 74d are dimensioned and shaped to conform to the dimensions and shapes of the lips 50a, 50b, 50c and 50d of the lens portion 36. As best shown in FIGS. 8 and 9, the recess 74c is formed on the mounting flange 72 of the inboard section 64 of the housing portion 38.

As indicated in FIGS. 4, 6 and 8, the mounting flange 72 is dimensioned to extend into the access opening 18 and includes two mounting apertures 78 (shown in FIG. 6). More specifically, the mounting flange 72 extends into the access opening 18 along a portion of the recessed surface 26. As indicated in FIGS. 3, 4 and 8, a pair of fasteners F removably inserted through the mounting apertures 78 and into the fastener receiving apertures 30 removably mount the lamp assembly 12 to the recessed surface 26 of the access opening 18 of the vehicle body 13. Further, the mounting flange 72 extends along a portion of the recessed surface 26 behind the closure member 20, inboard of the outboard lateral edge 25 with the closure member 20 in the closed position.

As indicated in FIGS. 6, 8 and 9, the recesses 74a, 74b, 74c and 74d define a continuous slot that is configured to mate with and attach to the lens portion 38. As best shown in FIG. 6, the recesses 74a, 74b, 74c and 74d encircle the first and second reflecting cones 68 and 70. The recesses 74a, 74b, 74c and 74d follow the overall respective contours and shapes of the outboard section 60, the upper section 62, the inboard section 64 and the lower section 66 of the housing portion 38. The recesses 74a, 74b, 74c and 74d further define lens attachment portions. Specifically, the recess 74a defines an outboard lens attachment portion, the recess 74b defines an upper lens attachment portion, the recess 74c defines an inboard lens attachment portion and the recess 74d defines a lower lens attachment portion.

The recess 74c (the inboard lens attachment portion) is located on the mounting flange 72 and is spaced apart from an inboard edge 80 of the mounting flange 72. The recess 74c is approximately straight with slight curvature. As indicated in FIG. 4, the recess 74c is positioned such that with the closure member 20 in the closed position, the closure member 20 covers the recess 74c.

As indicated in FIG. 8, the lips 50a, 50b, 50c and 50d of the lens portion 36 are inserted into respective ones of the recesses 74a, 74b, 74c and 74d of the housing portion 38. Specifically, during the manufacturing process, the lips 50a, 50b, 50c and 50d of the lens portion 36 are inserted into the recesses 74a, 74b, 74c and 74d of the housing portion 38 and are fused, glued, hot melt welded or otherwise permanently and non-removably fixed to the lens attachment recess 46 to create a water tight seal between the lens portion 36 and the housing portion 38.

As indicated in FIG. 8, with the lamp assembly 12 fully assembled and installed to the lamp receiving recess 22 of the vehicle 10, the mounting flange 72 of the housing portion 38 and the inboard flange 48 of the lens portion 36 extend over a portion of the recessed surface 26 of the access opening 18. Further, the lip 50c (the inboard housing attachment portion) and the recess 74c (the inboard lens attachment portion) are disposed inboard of the outboard lateral edge 25 of the closure member 20 and concealed by the closure member 20 when the vehicle closure member is in the closed position.

It should be understood from the drawings and the description herein, that the lips 50a, 50b and 50d and the recesses 74a, 74b and 74d are less visible and more easily obscured than are lip 50c and the recess 74c. This is because little if any light from lamps in the first and second reflecting cones 68 and 70 shine through the outboard section 40, the upper section 42 and the lower section 46 of the lens portion 36 of the lamp assembly 12. In conventional lamp assemblies, if a seam is formed between the housing portion and the lens portion in an area of the lens portion where light shines, then that conventional seam is visible. However, in the present invention, since the lip 50c (the inboard housing attachment portion) of the lens portion 36 and the recess 74c (the inboard lens attachment portion) of the housing portion 38 are positioned such that they are covered and hidden inboard from the outboard lateral edge 25 by the closure member 20, the lamp assembly 12 has an improved appearance and improved light transmission.

Since the lip 50c (the inboard housing attachment portion) of the lens portion 36 and the recess 74c (the inboard lens attachment portion) of the housing portion 38 are disposed inboard from the outboard lateral edge 25 of the closure member 20 it is possible to increase the width of the closure member 20. Specifically, with the present invention as indicated in FIG. 2, the outboard lateral edges 25 of the closure member 20 can be farther apart compared to conventional structures without widening the vehicle body. In other words, the overall width of the closure member 20 can be wider than with an identical vehicle having a conventional lamp assembly. Similarly, with the present invention it is possible to design the vehicle 10 with an overall reduced width. Specifically, by concealing the lip 50c (the inboard housing attachment portion) of the lens portion 36 and the recess 74c (the inboard lens attachment portion) of the housing portion 38 concealed behind the closure member 20, less space is required for the lamp assembly 12 compared to a conventional configuration.

It should be understood from the drawings and the description herein, that the lamp assembly 12 can be shaped and configured as a headlamp assembly where the first and second seam sections are hidden behind the hood of an engine compartment. Alternatively, the lamp assembly 12 can be shaped and configured for use as a tail lamp assembly of a pickup truck where the tailgate of the pickup truck covers the first and second seam section. Further, the lamp assembly 12 can be shaped and configured for use as a tail lamp assembly on a passenger vehicle adjacent to the trunk lid.

The vehicle 10 includes conventional components that are well known in the art. Since vehicles and vehicle bodies are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the present invention. Accordingly, these terms, as utilized to describe the present invention should be interpreted relative to a vehicle equipped with the present invention.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle structure comprising:
a vehicle body having a lamp housing receiving portion and defining an access opening inboard to the lamp housing receiving portion;
a vehicle closure member supported on the vehicle body to move between an open position exposing the access opening and a closed position covering the access opening, the vehicle closure member having an outboard lateral edge;
a lamp housing removably disposed within the lamp housing receiving portion having at least one lamp receiving portion and an inboard lens attachment portion; and
a lamp lens configured to allow transmission of light therethrough having an inboard housing attachment portion that is fixedly attached to the inboard lens attachment portion,
wherein the inboard housing attachment portion and the inboard lens attachment portion are disposed inboard of the outboard lateral edge of the vehicle closure member and concealed by the vehicle closure member when the vehicle closure member is in the closed position.

2. The vehicle structure according to claim 1, wherein
the vehicle body includes a mounting surface between the access opening and the lamp housing receiving portion wherein the vehicle closure member conceals at least a portion of the mounting surface.

3. The vehicle structure according to claim 2, wherein
the inboard lens attachment portion of the lamp housing and the inboard housing attachment section of the inboard portion of the lamp lens extend over a portion of the mounting surface adjacent to the lamp receiving portion of the vehicle body.

4. The vehicle structure according to claim 2, wherein
the lamp housing includes a mounting flange that extends along a portion of the mounting surface and is removably attached to the mounting surface.

5. The vehicle structure according to claim 4, wherein
th the inboard lens attachment portion is located on the mounting flange of the lamp housing.

6. The vehicle structure according to claim 5, wherein
the inboard lens attachment portion of the lens housing includes a slot dimensioned to receive a lip of the inboard housing attachment section of the lamp lens.

7. The vehicle structure according to claim 6, wherein
the slot of the inboard lens attachment portion of the lens housing is fixedly attached to the lip of the inboard housing section of the lamp lens with a water-tight seal.

8. The vehicle structure according to claim 1, wherein
the lamp housing includes a mounting portion that extends inboard and is removably attached to the vehicle body.

9. The vehicle structure according to claim 8, wherein
the inboard lens attachment portion is located on the mounting portion of the lamp housing.

10. The vehicle structure according to claim 9, wherein
the inboard lens attachment portion of the lens housing includes a slot dimensioned to receive a lip on the inboard housing attachment section of the lamp lens.

11. The vehicle structure according to claim 10, wherein
the slot of the inboard lens attachment portion of the lens housing is fixedly attached to the lip of the attachment inboard housing section of the lamp lens with a water-tight seal.

12. The vehicle structure according to claim 1, wherein
the inboard lens attachment portion of the lens housing includes a slot dimensioned to receive a lip on the inboard housing attachment section of the lamp lens.

13. The vehicle structure according to claim 12, wherein
the slot of the inboard lens attachment portion of the lens housing is fixedly attached to the lip of the inboard housing attachment section of the lamp lens with a water-tight seal.
